(19) United States
(12) Patent Application Publication
(10) Pub. No.: US 2010/0278321 A1
(43) Pub. Date: Nov. 4, 2010

(54) PHONECASTING REFERRAL SYSTEMS AND METHODS

(76) Inventor: Michael A. Sharp, Porter, TX (US)

Correspondence Address: ATER WYNNE LLP, 1331 NW Lovejoy St. Suite 900, PORTLAND, OR, 97209-2785, US

(21) Appl. No.: 12/735,323

(22) PCT Filed: Jan. 2, 2009
(86) PCT No.: PCT/US09/30007

§ 371 Date: Jul. 2, 2010

Related U.S. Application Data
(60) Provisional application No. 61/018,932, filed on Jan. 4, 2008.

(51) Int. Cl. H04M 1/64

(52) U.S. Cl. 379/88.22

(57) ABSTRACT

Incoming phone calls are answered with playback of an audio feed. A listener can enter a phone number or other identifier to refer a friend. A message recommending the phonecast is then sent to the friend, possibly including a link or some other form of a ‘click-to-call’ facilitation. In some embodiments, the message is a text message sent via the short-message service (SMS) system. Email or voice mail messages may alternatively be employed. The referral identifier is captured along with identifying information of the caller and any message the caller wishes to provide. The system generates recommendation messages based on the captured information.

### BACKGROUND

With the development of Apple Inc.'s iPod®, portable players for digital media entered the mainstream. Such portable media players routinely provide compact storage and playback of thousands of songs, and recent models include capabilities for storing and playing videos as well. The widespread availability of such devices created a platform for a new method of communication: podcasting. The term “podcast” is a combination of the words “iPod” and “broadcast”, and it in essence refers to the ability to syndicate an audible program to subscribers' portable media players.

The podcasting process begins with a content provider publishing an audio file on the Internet. The content provider then references that audio file in a syndication file, which in addition to the uniform resource locator (URL) of the audio file, typically includes additional information such as title, description, publication date, etc., of the audio program along with similar information for previous episodes of the program. The syndication file is commonly in a Really Simple Syndication (RSS) format, though other standard formats are also suitable. The syndication file has a fixed URL so that software on subscribers' computers can periodically check for new material. When new material is detected, the software typically downloads the newest audio file automatically so that it can be easily transferred to the portable media players the next time a synchronization is performed. In this manner, owners of media players are theoretically able to maintain dynamic and current content on their media players for “on the go” listening.

Podcasting has achieved widespread success. However, the podcasting process may have a number of shortcomings that have not been adequately identified and addressed heretofore. For example, podcast subscribers are required to have some amount of foresight regarding their listening preferences when subscribing and, moreover, must remember to charge, synchronize, and bring their portable media players (and headphones) with them for every circumstance in which they might wish to listen to their preferred podcast content. Often, some oversight in the subscribing, downloading, charging, synchronization, and custody process will leave a user without any ability to listen to the latest podcast material.

As another example, the podcast process typically imposes a significant degree of latency between the publication of the material and the subscriber's listening experience. For some subscribers, this latency is undesirable. It is perhaps unsurprising that, according to a consumer survey reported by TDG (The Diffusion Group) Research, the vast majority of downloaded podcasts are never transferred to a portable media player, but rather are played directly on networked computers.

To at least partly address these issues, the present assignee has invented certain phonecasting systems and methods as described in U.S. patent application Ser. 11/877,612, filed Dec. 23, 2007. Though these systems and methods have proved wildly successful, there may nevertheless be room for improvements and additional features.

### SUMMARY

The present application discloses inventive referral systems and methods suitable for use with a phonecasting system. At least some of the method embodiments answer incoming phone calls with playback of one or more podcasts or some other form of audio feed. A listener can enter a phone number or other identifier to refer a friend. A message recommending the phonecast is then sent to the friend, possibly including a link or some other form of a “click-to-call” facilitation. In some embodiments, the message is a text message sent via the short-message service (SMS) system. Email or voice mail messages may also or alternatively be employed.

At least some phonecasting system embodiments include a network server having a memory and at least one processor coupled to the memory to execute playback software stored therein. The playback software configures the processor to receive an incoming phone call and responsively play back an audio feed, and further configures the processor to detect entry of a referral identifier. The referral identifier is captured, along with identifying information of the caller and any message the caller wishes to provide. The software configures the processor to communicate these items to a database server. The system then sends recommendation messages based on the information stored in the database.

At least some of the foregoing phonecasting methods and systems simplify public access to Internet content via any phone, thereby increasing the commercial potential for phonecasting. Users need only receive and provide referrals to be kept “in the know”, i.e., to have access to the most popular podcast material on the Internet.

### BRIEF DESCRIPTION OF THE DRAWINGS

A better understanding of the various disclosed embodiments can be obtained when the detailed description is considered in conjunction with the following drawings, in which:

FIG. 1 is an environmental view of an illustrative phonecasting system;

FIG. 2 is a functional block diagram of an illustrative phonecasting system server;

FIG. 3 is a function block diagram of illustrative phonecasting system software;

FIG. 4 shows an illustrative front end web page;

FIG. 5 is a flowchart of an illustrative phonecast listening method;

FIG. 6 is a flowchart of an illustrative phonecast playback method;

FIG. 7 is a flowchart of an illustrative phonecast setup method;

FIG. 8 is a flowchart of an illustrative automated download method;

FIG. 9 is a flowchart of an illustrative phonecast parameter configuration method;

FIG. 10 is a flowchart of an illustrative phonecast setup method for publishers;

FIG. 11 is a flowchart of an illustrative ad setup method for advertisers;

FIG. 12 is a flowchart of an illustrative phonecast recording method;

FIG. 13 is a flowchart of an illustrative phonecast system setup method for administrators;

FIG. 14 is a simplified environmental view of an illustrative phonecasting system;

FIG. 15 is a diagram of a system including a server system and a telephone caller in audio communication via a connection established through a communication network;

FIG. 16 is a diagram of the system of FIG. 15 wherein the server system is receiving referral information from the caller;

FIG. 17 is a is a diagram of the system of FIGS. 15-16 wherein the server system has placed a telephone call to a referred person, and the server system is in audio communication with the referred person via a connection established through the communication network; and

FIG. 18 is a flowchart of one embodiment of a method for delivering audio content to a referred person.

While the disclosed inventions are susceptible to various modifications and alternative forms, specific embodiments thereof are shown by way of example in the drawings and will herein be described in detail. It should be understood, however, that the drawings and detailed description thereto are not intended to limit the inventions to the particular form disclosed, but on the contrary, the intention is to cover all modifications, equivalents and alternatives falling within the spirit and scope of the inventions as defined by the appended claims.

### TERMINOLOGY

The term “feed” as used herein refers to a program, presentation, or other content made available for transmission or conveyance via the Internet. A feed can exist in various forms, including a podcast, a song or other fixed sound file, a periodically updated sound file, and a live media stream.

The term “phonecast,” when used herein as a noun, refers to a feed that can be accessed with a phone over the public switched telephone network (PSTN) and/or over a voice over internet protocol (VoIP) channel. When used herein as a verb, the term “phonecast” refers to the transmission or conveyance of a feed over a VoIP or PSTN channel to a phone.

The term “includes” as used herein is an open-ended term, as in “including, but not limited to”.

### DETAILED DESCRIPTION

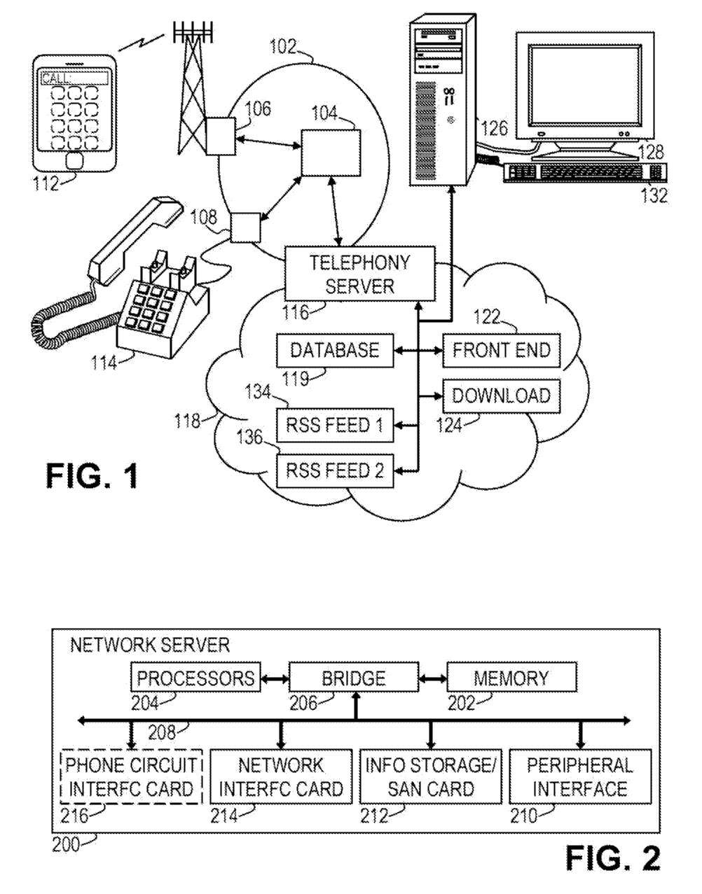

Turning now to the figures, FIG. 1 shows an illustrative phonecasting system. The public switched telephone network (PSTN) 102 includes a hierarchy of switches 104, 106, 108, and communication links that interconnect customer provided equipment (CPE) such as cell phones 112, “land-line” phones 114, and modems. A telephony server 116 couples to the PSTN 102 to initiate and receive phone calls. Often (though not necessarily) the telephony server 116 connects to the PSTN 102 via a trunk line that supports multiple simultaneous calls.

The telephony server 116 also couples to the Internet 118 to optionally send and receive streams of audio data. Alternatively, sound files can be played and recorded internally by telephony server 116. Telephony server 116 may be an Asterisk™ server (or a farm of such servers), the setup and operation of which is described in detail in J. Van Meggelen, J. Smith, and L. Madsen, Asterisk: The Future of Telephony, © 2005 O'Reilly Media, Inc., Farnham.

Together with the telephony server 116, the illustrative phonecasting system includes a database server 119, a front end server 122, and a download server 124. The telephony server 116 relies on the database server 119 to determine the audio program and introductory message that corresponds to the dialed phone numbers of incoming calls. (In some embodiments, the determination of an introductory message may also depend on the caller ID information for the incoming call.) With the links provided by the database server 119, the telephony server 116 initiates streaming of the appropriate files from the download server 124. The front end server 122 provides a web site that serves as a phonecasting system interface for Internet users. Internet users typically will run web browser software on their computers 126. The web browser software displays a web page on their monitor 128, with one or more fields for the user to populate via an input device 132.

Among other things, Internet users will be able to enter Internet feed identifiers for, e.g., RSS (“really simple syndication”) feeds 134, 136. The front end server 122 accesses the database server 119 to determine whether phone numbers have previously been assigned, and if not, the front end server retrieves an available phone number from the database and assigns it to the feed. If the phone number is newly assigned, the front end server 122 also notifies the download server 124 to initiate retrieval and translation of the feed. Once a phone number has been assigned, the front end server 122 generates a web page for display on the user's computer monitor 128, showing the assigned phone number.

Some embodiments of this displayed web page include a field for the user to enter referral information. For example, the user may be able to enter his/her own phone number and the phone numbers of one or more friends to have a text message or phone call automatically delivered. Alternatively, email addresses or other identifiers may be provided to deliver other forms of automatic messages. The automatic messages may include the phone number for listening to the feed, along with identifying information of the person sending the recommendation.

Though the illustrative system is shown as including four servers having separate functions, these functions can be consolidated and/or distributed as needed to provide the appropriate server capacity. FIG. 2 is a functional block diagram of an illustrative phonecasting system server 200, which may serve a portion or some combination of the functions outlined previously. The server 200 includes a memory 202, one or more processors 204, and a high-speed bridge that connects the processor(s) 204 with the memory 202 and the expansion bus 208. The expansion bus 208 supports communication with a peripheral interface 210, information storage device 212, network interface card 214, and an optional phone circuit interface card 216.

Peripheral interface 210 provides ports for communicating with external devices such as keyboard, mice, universal serial bus (USB) devices, printers, cameras, speakers, etc. On many servers, these ports may be left largely unused, but they are available for configuration, diagnostic, performance monitoring purposes. Information storage device 212 is typically a nonvolatile memory for firmware and/or a hard drive for extended storage of software and data. On distributed systems with high data availability requirements, the information storage device 212 is replaced or supplemented with a storage area network (SAN) card that enables shared access to a large disk array. A network interface card 214 provides access to other network servers and usually to the Internet as a whole. Finally, in the telephony server, an interface card for the telephone circuits is optionally included. In some alternative embodiments, the connection to the PSTN is accomplished indirectly via Voice over Internet Protocol (VoIP) techniques, eliminating the need for dedicated telephone circuit interface hardware.

Before the illustrative server 200 boots, the relevant phonecasting software components are stored on the local hard drive 212, or sometimes on a network disk accessible via the network interface card. After the initial boot-up diagnostics are completed, the processor(s) loads the phonecasting software components into memory, either all at once or on an “as needed” basis (e.g., by paging the needed instructions into memory). As the processor(s) execute the software instructions, the software configures the operation of the illustrative server(s) in accordance with the methods and principles set forth herein.

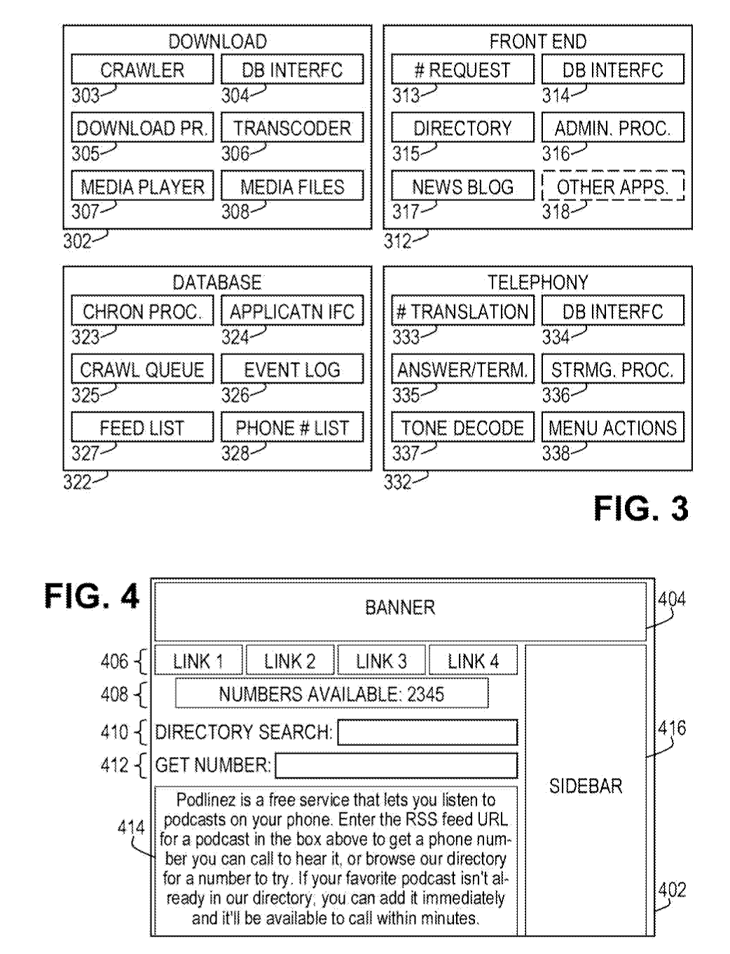

FIG. 3 is a function block diagram of illustrative phonecasting system software. Though numerous independently executing processes exist, they can be grouped into four functional groups that correspond with the four servers of the illustrative phonecasting system: the telephony server, the database server, the front end server, and the download server. These will be addressed in reverse order, and initially at a high level. Thereafter, a more detailed discussion will be provided regarding a number of the more pertinent methods carried out by the phonecasting system.

The illustrative download software 302 performs an automated downloading and translation function to make Internet multimedia files locally available, and it optionally streams the multimedia files on demand. The illustrative download software 302 includes a crawler 303, a database interface 304, a download process 305, a translation process 306, a streaming media player 307, and a media file storage hierarchy 308. The database interface process 304 establishes a connection to the database software 322 to assure coherent and reliable database access for the other download processes. Via the interface 304, the crawler 303 periodically retrieves a list of feeds that need to be checked for updates. The list includes information regarding the last download of the feeds, such as episode number, title, file size, and publication date. The crawler then checks the feeds on the Internet for updates or changes relative to the last download. If an update or other change is detected, the crawler 303 notifies the download process 305 to retrieve the latest version of the relevant sound or multimedia file. The illustrative download process 305 is designed to conduct multiple downloads with redundancy and tolerance for errors or temporary outages.

As the download process 305 completes the retrieval of each multimedia or sound file, the illustrative translation process 306 converts the audio component of the file into a format suitable for playback over a telephone connection. For example, MP3 files may be converted to uncompressed audio, re-sampled to 8 kHz monaural, and companded using a μ-law companding algorithm. In this format, the media player 307 can (upon demand) stream the file to a telephone connection with minimal processing. As the translation process 306 completes, the files are stored in a file hierarchy 308 with any given standard naming convention, and the translation process 306 notifies the database of a successful download.

The illustrative front end software 312 provides a web interface to the phonecasting system. It includes a request component 313, a database interface process 314, a directory component 315, an administrative component 316, a news blog 317, and other optional applications 318. As before, the database interface process 314 establishes a connection to the database software 322 to assure coherent and reliable database access for the other front end processes. The request component 313, the directory component 315, the administrative component 316, and the news blog 317 may each take the form of web pages having fields for receiving user input and software modules for appropriately processing the user input. The illustrative request component 313, for example, includes a field for specifying a feed identifier, which if filled, causes the request component to obtain and display a phone number for that feed. The illustrative request component 313 first accesses the database to determine if a phone number has been previously assigned, and if not, the request component 313 requests that an available phone number from the database be assigned to the feed.

The illustrative directory component 315 enables keyword searching of the titles and identifiers for feeds having assigned phone numbers. The illustrative administrative component 316 enables an administrator to log in and monitor system operations. The administrator can further adjust usage thresholds for recycling relatively unused numbers (e.g., 60 days without a call), may add new blocks of phone numbers to the system, remove redundant numbers to a given feed, add additional numbers (or area codes) to heavily used feeds, and perform system backups. The news blog component 317 allows an administrator to publish the latest news and events for user convenience. Finally, the illustrative front end 312 includes other applications such as feed publishing utilities, podcast hosting services, advertiser bidding utilities, and utilities for gathering referral information.

The illustrative database software 322 includes a chronology process 323, an application interface process 324, a crawl queue 325, an event log 326, a feed list 327, and a phone number list 328. The chronology process 323 periodically reviews the database tables for certain occurrences, such as the elapsing of a specified interval since the last time a feed was checked for an update, or the number of available numbers falling below a threshold. When such occurrences are detected, the chronology process 323 performs a specified action. In the case of a feed not being recently checked for an update, the chronology process 323 places the feed identifier in the crawl queue, where it will be seen the next time the crawl process 303 checks. In the case of too few available phone numbers, the chronology process 323 may send a message to a designated email address and/or initiate the execution of a phone number recycling process.

The application interface process 324 cooperates with the database interface processes 304, 314, and 334 to establish database connections with the other server software. Crawl queue 325 is a database table containing a list of feed identifiers that need to be checked for updates. Event log 326 is a table for tracking database transactions. Feed list 327 is a table containing a list of all the feeds with their assigned phone numbers. Phone number list 328 is a table containing a list of all the available (unassigned) phone numbers.

The illustrative telephony software 332 performs automated call completion, connecting telephone channels to the Internet feed associated with the dialed number. Illustrative telephony software 332 includes a number translation module 333, a database interface process 334, a call answer/termination module 335, a streaming module 336, a tone decoding module 337, and a menu module 338. The number translation module 333 accesses the database to determine the feed or sound file and introductory message currently associated with the dialed phone number, and having determined them, passes the information to the call answer/termination module 335. Module 335 answers the call and monitors the connection while streaming module 336 coordinates with media player 307 to initiate playback of the introductory message and the sound file. If module 335 detects tone activity (e.g., from a caller pressing buttons on the keypad), the tone decode process 337 is invoked to determine which keys have been pressed. With the key presses determined module 335 can invoke the appropriate menu module 338. The menu module 338 generates the appropriate action, e.g., pausing, skipping forward or backward in the playback, switching to a previous/subsequent episode, collecting referral information, subscribing a user for future notifications, initiating a purchase of an advertised item, playing a menu of other options, etc.

FIG. 4 shows an illustrative front end web page 402 as it may be displayed to a public user by request component 333. Web page 402 includes a banner 404 identifying and branding the phonecasting service. A number of links 406 are provided for navigating the site, e.g., to access support or other services. A status box 408 specifies the number of currently unassigned phone numbers, which consequently are available to be assigned to an Internet feed. A labeled directory field 410 enables a user to enter keywords to search a directory of feeds already having assigned phone numbers. If a user presses “Enter” after having made an entry in this field, that user will be presented with a list of phone numbers and corresponding feed titles that match the keywords.

A labeled request field 412 enables a user to enter a uniform resource locator (URL) for a publicly-accessible feed. Upon pressing “Enter”, the user will be presented with at least one phone number that has been assigned to that feed. In some cases, a feed may have multiple phone numbers associated with it, e.g., numbers in different area codes. The web page 402 further includes a description 414 explaining how the phonecasting service works. A sidebar 416 is also provided to, e.g., display lists of most popular feeds and most recently accessed feeds.

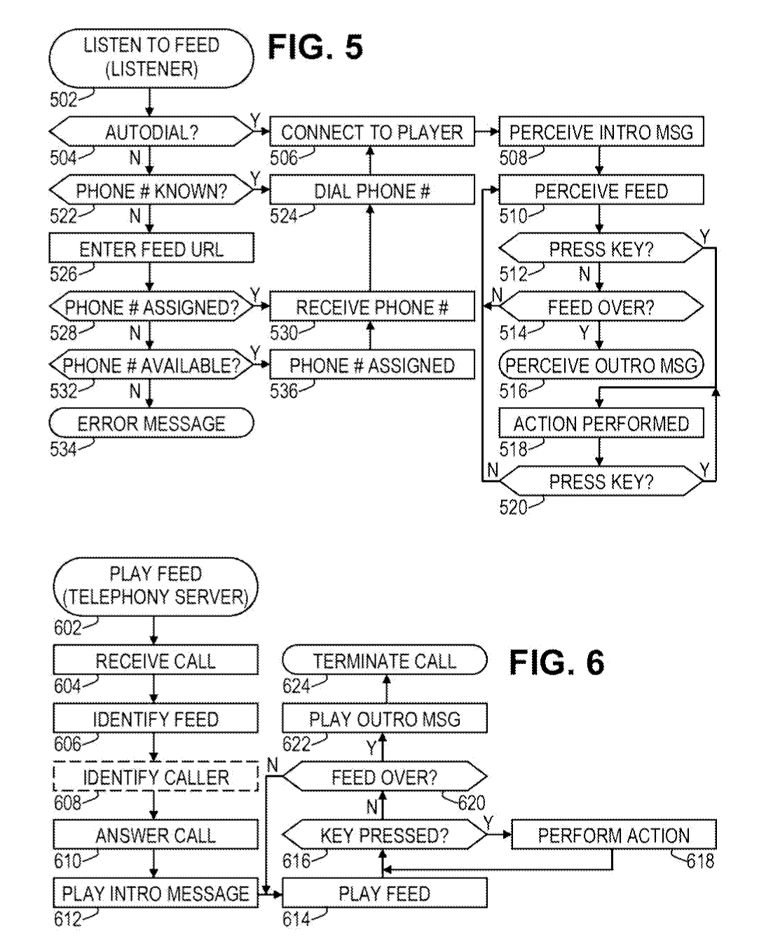

FIG. 5 is a flowchart of an illustrative phonecast listening method 502. Beginning in block 504, a user chooses whether or not to autodial a phonecast number. The autodial feature can be made available in a number of ways. One autodial method involves programming a speed dial or voice-recognition system to dial the phonecast number on demand. Another autodial method involves scanning a barcode or RFID (radio frequency identification) tag that provides (directly or indirectly) a phone number to a mobile phone. Yet another autodial method involves a “click to call” link embedded in a webpage, email, or SMS (short message service) message that invokes the computer or phone's autodialing function. These and other autodial methods enable a user to easily command a phone to call a phonecast number, so that the phone connects to a phonecast player in block 506.

In block 508, the listener hears (audio) or sees (video) an introductory message. The introductory message may be a simple welcoming message, a general advertisement, or a targeted advertisement selected on the basis of the caller ID information and/or the content of the feed. In some embodiments, the introductory message includes a personal introduction or explanatory comment recorded by somebody else who identified the listener via a referral process described further below. Though the introductory message can be limited to 10 or 15 seconds, other introductory message lengths are possible and may be desirable. In some system embodiments, the listener is unable to use pause or skip functionality during the introductory message.

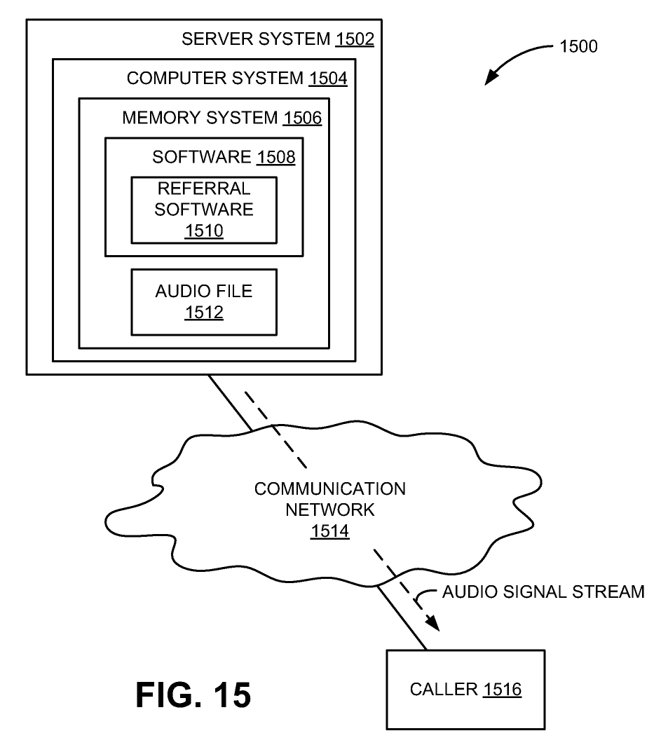

Once the introductory message terminates, the listener hears (audio) or views (video) the feed in block 510. In block 512 the listener can provide user input, e.g., in the form of a key press or voice command, until the feed terminates in block 514. (Once the feed ends, the listener hears or sees an “outro” or closing message as the call terminates in block 516. As described below with reference to FIGS. 15-18, the outro message may solicit referrals from the listener.) If the user provides user input in block 512, the system optionally pauses the feed to perform the action that is triggered by the user input in block 518. Absent further user input in block 520, the phonecast resumes in block 510.

A number of actions may be made available to the user in blocks 512, 518, and 520. Such actions include pausing the feed, skipping ahead, and skipping backward. Another possible action may be subscribing for instant notification of future updates to the material, in which case the system may capture caller identification (CID) or automatic number identification (ANI) information to enable voice mail or SMS message notifications to be sent. Another possible action may be initiating a purchase of some product or service discussed in the feed. Again, the system would capture the CID or ANI information and arrange to have the user's phone service provider provide delivery information and send a bill for the product or service. Yet another possible action is the entry of referral information such as a phone number and a recorded message for a friend who might also be interested in the feed.

Returning to block 504, if the autodialing option is not available, the user determines if he knows the phonecast phone number in block 522. The number may be known if the user has previously stored or memorized the number, or if it if being provided by an advertisement or by a friend. If the number is known, the user can dial the number in block 524 and the method proceeds as before.

If the number is not known block 522, the user accesses the front end software in block 526 and enters a feed identifier into a phone number request field. In block 528, the system determines if a phone number has been previously assigned, and if so, the user receives the phone number in block 530. If no number is currently assigned, the system determines in block 532 whether any unassigned phone numbers are available, and if so, the system assigns a phone number in block 536. Otherwise, an error message is presented in block 534, and a notification is sent to the administrator so that the situation can be rectified.

FIG. 6 is a flowchart of an illustrative phonecast playback method 602. Beginning in block 604, the telephony server receives a call to a dialed number. In block 606, the telephony server accesses the database to determine which feed or multimedia file is currently associated with that dialed number. In optional block 608, the telephony server collects the CID or ANI information. If collected, this information may be used for statistics generation, targeted advertising, subscription services, notification services, purchasing services, playback of recorded referral messages, or to provide customized user options (e.g. personalized volume, playback speed, bookmarks, etc.). In block 610, the telephony server answers the call, and in block 612, the telephony server initiates playback of an introductory message 612. In at least some method embodiments, playback pause and skip-forward functionality is suspended during the introductory message. After the introductory message finishes, the telephony server initiates playback of the feed corresponding to the dialed number. In blocks 616 and 618, the telephony server detects user input and performs the corresponding actions. Such user interaction may be allowed to continue until the system determines that the feed is complete (or that the user terminated the connection) in block 620. Once the feed is complete, the telephony server optionally plays a closing message in block 622 and terminates the call in block 624.

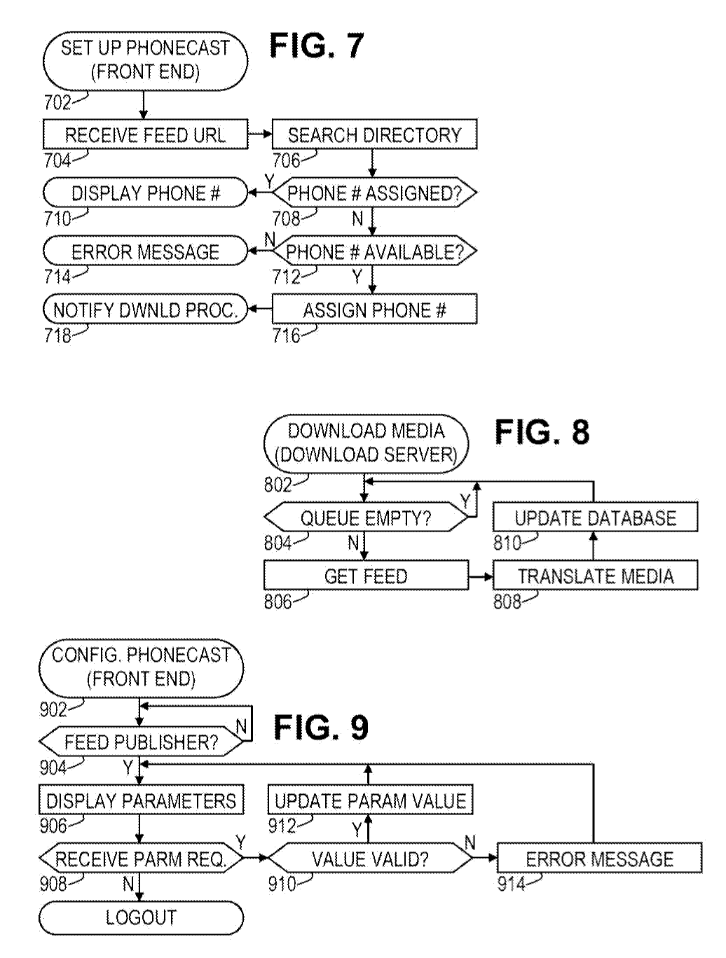

FIG. 7 is a flowchart of an illustrative Internet-based phonecast setup method 702. Beginning in block 704, the front end server receives a feed identifier such as a URL for a podcast. In block 706, the front end server searches a database or other form of directory to determine if the feed identifier already has a phone number assigned. In block 708, the front end server checks to determine if the search was successful, and if so, the front end provides (in block 710) the phone number for display to the source of feed identifier. In some embodiments, the provided phone number is accompanied by a solicitation for referral information. If the search was unsuccessful, the front end server determines in block 712 whether any phone numbers are available for it to assign to the feed, and if not, the front end sends an error message in block 714. If a number is available, the front end server assigns the phone number to the feed in block 716 (by updating the database or directory) and notifies the download software that new content needs to be retrieved and prepared for phonecasting.

Note that the method described in FIG. 7 is not limited to web page-based data entry and response. The publicly-accessible front end server may be configured to receive and respond to phone number requests with feed identifiers in a variety of formats, including email, SMS messages, XML files, and other communication methods.

FIG. 8 is a flowchart of an illustrative automated download method 802 that may be implemented by the download server. Beginning in block 804, the download software determines whether the download queue is empty. The download queue lists files for retrieval by the download software, along with desired destination and a subroutine call to specify success or failure of the retrieval attempt. The download queue may be populated with new feeds by the front end server, and with updated feeds by a crawler component of the download software. In each case, the new or updated content will be associated with a corresponding phone number once the download is complete.

If the download queue is not empty, then in block 806, the download software retrieves the feed. (Although the download software makes provisions for temporary outages and failures, that level of detail is not of crucial importance to this disclosure). In block 808, the download software translates the feed from its original format to a phonecasting format as described previously. In block 810, the download software notifies the database that the feed is ready for phonecasting.

FIG. 9 is a flowchart of an illustrative phonecast parameter configuration method 902. Beginning in block 904, the front end determines whether or not it is the feed publisher that is attempting to configure the phonecast. This determination can be performed by having the phonecast publisher log in to an account, or otherwise provide verification that the publisher is who they claim to be. In some cases the publisher may be asked to include a verification code in their syndication file to establish their identity.

In block 906, the front end software displays the current phonecast parameters. In block 908, the front end determines whether the publisher wishes to modify any parameters, and if not, the process terminates. Otherwise, in block 910, the front end determines whether the new parameter value is valid or not. If so, the front end updates the parameter value in block 912. If not, an error message is published in block 914, and the updated parameter values are redisplayed in block 906. Examples of the various parameter values that can be set are provided in the following figure.

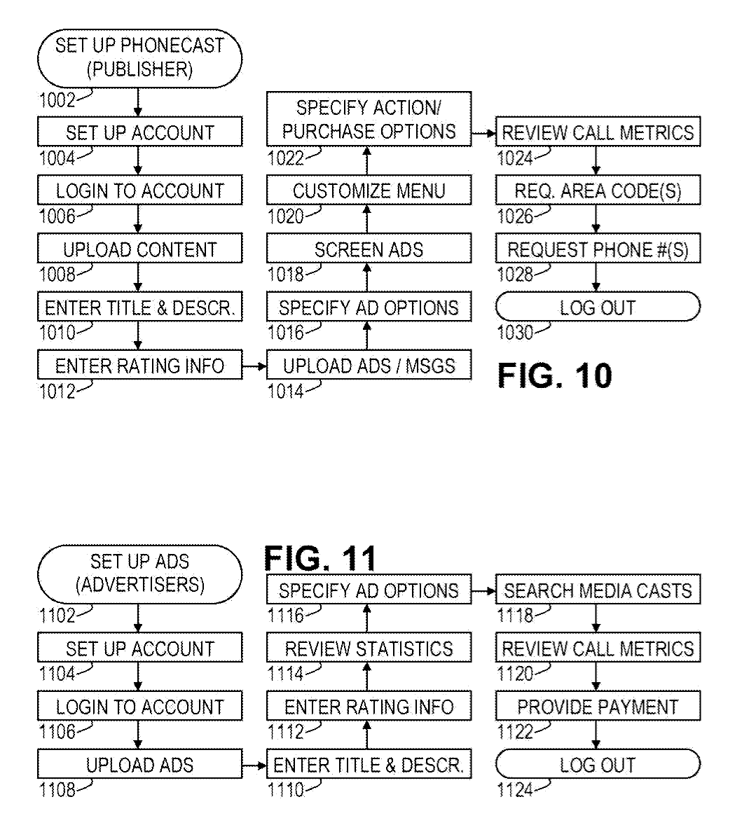

FIG. 10 is a flowchart of an illustrative phonecast setup method for publishers 1002. Beginning in block 1004, the publisher sets up an account in the podcasting system. The account setup process provides some mechanism for assuring that the person setting up the account is indeed the publisher or somebody operating on the publisher's behalf. In block 1006, the publisher logs into his account. In block 1008, the publisher uploads a feed to the podcasting system. This action is optional and may be unnecessary unless the publisher is using the podcasting system as his hosting system. In block 1010, the publisher enters a title and description for the feed, and in block 1012, the publisher enters rating information. Again, these actions are optional and may be unnecessary if the feed is syndicated on the Internet, in which case the podcasting system can retrieve this information automatically.

In block 1014, the publisher has the option to upload introductory messages and/or advertisements for use with his podcast. In some method embodiments, the publisher may be expected to pay for this option. In block 1016, the publisher can specify options for the messages or advertisements, including desired budget, desired presentation frequency, desired targeting parameters (e.g. CID area codes), calendar schedules for different ads, limitations on 3rd party advertisements (e.g., no automotive ads, or no competitor ads), and so on. In block 1018, the publisher may be presented with the ads he has uploaded and any 3rd party ads that qualify under the options he has set, as part of a screening process. The publisher may be permitted to reject ads or affirmatively select or express preferences regarding the screened ads.

In block 1020, the publisher may customize menu options for the podcast listener, including custom voice menus for listeners that provide user inputs requesting standard actions (pause, skip, notification subscription, listen to previous episode, etc). In block 1022, the publisher can specify unique actions or purchase options that are triggered by the appropriate user inputs. For example, certain keys might be designated as voting keys for users to participate in surveys, or a key may be provided to request more information about the current topic, etc. Publishers may be given access to a set of customizable action modules that will be triggered by the appropriate key press or voice input. In accordance with the present disclosure, the set of action modules includes a referral module that, in response to a selection of the appropriate menu item, captures referral information and generates a customizable recommendation message as described further below with reference to FIGS. 15-18.

Continuing with the present setup example, in block 1024, the publisher may review call metrics, i.e., statistics about the numbers, frequencies, distributions, and lengths of calls to the podcast. Based in part on such statistics, the publisher may request that the feed be assigned numbers in specific area codes in block 1026, or even request a specific vanity number in block 1028. It should be noted that the sequence of actions described in FIG. 10 is illustrative and can be readily re-arranged with certain actions added or omitted per the immediate needs of the publisher. Once finished with the setup process, the publisher logs out in block 1030.

FIG. 11 is a flowchart of an illustrative ad setup method 1102 for advertisers. Beginning in block 1104, the advertiser sets up an account. This action only needs to be performed once per advertiser. In block 1106, the advertiser logs in to his account and uploads advertisements in block 1108. In block 1110, the advertiser enters titles and short descriptions of the advertisements, and further provides rating information in block 1112. In block 1114, the advertisers can review the statistics for their advertisements, such as number of times presented, frequency on each podcast, average frequency to each CID, advertising costs, and so on. In block 1116, the advertisers can specify their advertising options including calendar limitations, podcast rating limitations, maximum number of ad showings, and so on. In block 1118, the advertisers may search or screen a list of podcasts to specify preferences or prohibitions for advertising on certain podcasts. In block 1120, the advertisers may also review the call statistics for selected podcasts to verify that the have sufficient call volume and coverage of the desired markets (e.g., area codes or other CID/ANI data that may be indicative of geographic or demographic markets). In block 1122, the advertisers can provide payment information and/or bids for their desired advertising parameters. As before, the sequence of actions described here is illustrative and can be readily re-arranged with certain actions added or omitted per the immediate needs of the advertiser. Once finished with the setup process, the advertiser logs out in block 1124.

FIG. 12 is a flowchart of an illustrative phonecast recording method 1202 that may be used as an alternative to uploading a feed via the Internet. Beginning in block 1204, the publisher dials the phone number assigned to his phonecast. In block 1206, the publisher presses a key that triggers a recording option, and in block 1208 enters a personal identification number (PIN) in response to a voice prompt. If the PIN is accepted, the publisher hears a voice prompt in block 1210 to “start recording”. In block 1212, the publisher speaks or otherwise provides a sound stream over the phone connection as the phonecasting system records it. When finished, the publisher types a key to stop the recording process in block 1214. In block 1216, the publisher is given the option to review the recording, and if he chooses that option, the recording is played back in block 1218, with the publisher allowed to pause, skip forward, and skip backward. In block 1220, the publisher presses a key to designate an edit point. The edit point may be used to mark an insertion point or to demarcate a deletion/replacement portion of the recording. Alternatively, a key may be pressed to terminate the screening process in block 1222. For insertions or replacements, the publisher does additional recording beginning with block 1212.

Once the screening/editing process is completed, the publisher enters a title in block 1224 and a description in block 1226. The preferred format for the title and description is text, and accordingly, the title and description entry may be performed using any standard keypad-entry technique such as “triple-tap”, with or without predictive word completion, and “single-tap” word recognition. Alternatively, voice-to-text technology may be employed. In block 1228, the publisher selects the role of the recorded content, i.e., whether the recorded content is the main feed, or whether it is an advertising message. In block 1230, the publisher is given the option to perform further content recording, and if he declines, the call is terminated in block 1232.

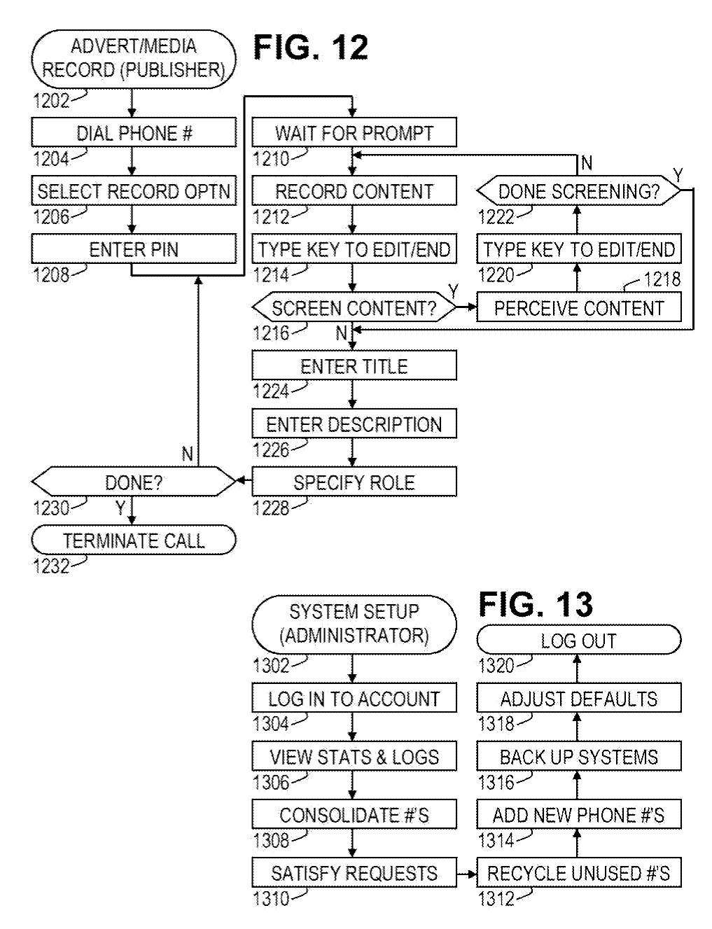

FIG. 13 is a flowchart of an illustrative phonecast system setup method for administrators 1302. Beginning with block 1304, the administrator logs into his account. In block 1306, the administrator reviews the logs and performance statistics of the phonecasting system for any sign of problems, such as available capacity, congestion, adequate resources (including unassigned phone numbers). In block 1308, the administrator reviews feed identifiers identified by a consolidation process as being suspiciously similar or redundant. If the administrator identifies the feeds as being the same, the administrator consolidates them, so that all the associated phone numbers will refer to the same feed. If the resulting group of phone numbers is excessive, the lesser-used phone numbers may be designated for a “phase out”, i.e., a temporary message referring callers to one of the remaining phone numbers for that feed.

In block 1310, the administrator reviews manual configuration requests. Primarily, these requests are expected to be multiple phone numbers for a given feed (e.g., one phone number in each area code for a national or regional program), and requests for a specific “vanity” number for a given feed. To the extent that the software doesn't handle such requests automatically, the administrator may manually make the necessary changes to the database to satisfy those requests that can be feasibly satisfied.

In block 1312, the administrator recycles phone numbers that have been assigned to feeds but are relatively unused (e.g., no calls in the last 60 days). This action may be unnecessary so long as an adequate pool of numbers remains available. Conversely, if this action is insufficient, the administrator may add a new block of phone numbers to the pool in block 1314. In block 1316, the administrator initiates a backup of the and database and current configurations of the software. In block 1318, the administrator adjusts the defaults if needed. Such defaults may include thresholds for number recycling, crawling frequencies to check for updates, archived episode age limits, and so on. The sequence of actions described here is illustrative and can be readily re-arranged with certain actions added or omitted per the immediate needs of the administrator. Once finished, the advertiser logs out in block 1320.

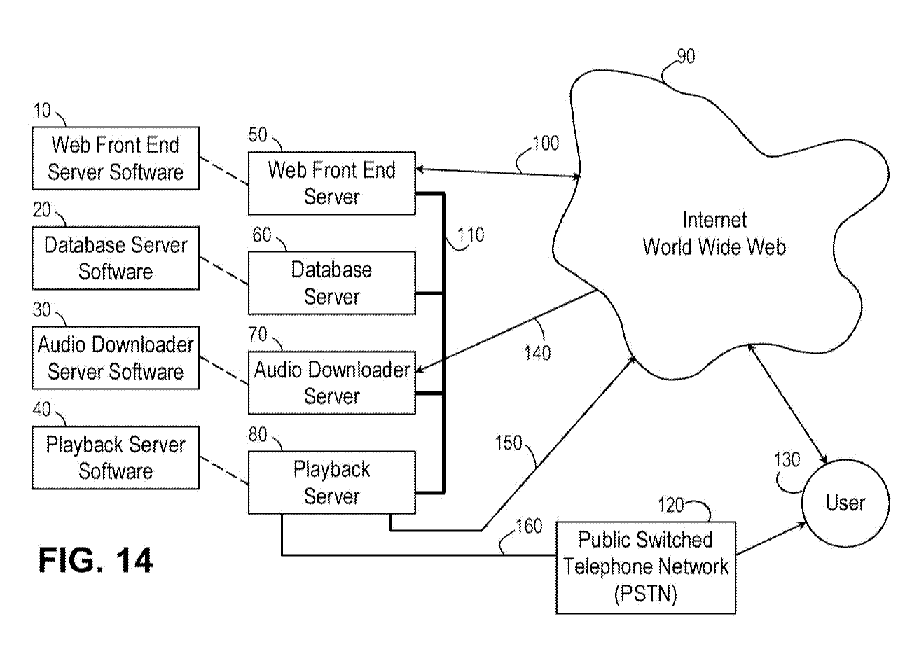

FIG. 14 is a simplified environmental view of an illustrative phonecasting system that supports a method of allowing telephone callers to hear multimedia files syndicated on or otherwise distributed via the Internet. The system in FIG. 14 includes the following components:

10 is web front end server software.

20 is database server software.

30 is audio downloader server software.

40 is playback server software.

50 is a web front end server.

60 is a database server.

70 is an audio downloader server.

80 is a playback server.

90 is the Internet/World Wide Web.

100 is a web connection.

110 is an inter-server network

120 is a public switched telephone network (PSTN).

130 is a user.

140 is an RSS and audio download connection.

150 is an optional VOIP trunk.

160 is a telephone network trunk.

A computer attached to the Internet/World Wide Web 90 and running the web front end server software 10 accepts requests for audio programs that a user or listener wishes to be associated with a telephone number. A computer running the database server 20 stores the mapping between audio programming links and phone numbers. A computer attached to the Internet/World Wide Web 90 and running the audio downloader server software 30 downloads metadata information about the audio programming, downloads the multimedia files comprising the audio programming, translates that into a format that may be played on a PSTN 120, and stores that translated data.

The playback server 80 is a computer attached either directly or indirectly to the Internet/World Wide Web 90 and the PSTN 120. The playback server 80 receives calls and plays audio to the listening caller. The playback server 80 might be directly attached to the PSTN 120 through a switched or dedicated telephone line or trunk. The playback server 80 might be indirectly attached to the PSTN 120 through a Voice over Internet Protocol (VoIP) connection.

The web front end server 50 accepts requests for audio programs that a user or listener wishes to be associated with a telephone number. The database server software 20 is consulted to determine if such an association already exists. If so, the associated phone number is provided to the user or listener, otherwise a new association is created and stored in the database server software 20 and provided to the user or listener. It is noted that the above association might be created by the original publisher of the audio programming instead of by a listener. The above association might also be used to create an index which may be browsed by users or listeners on the web front end server 50.

An audio downloader server software 30 uses the above database and downloads the metadata information and the multimedia files containing the audio programming either ahead of time or simultaneously (“streaming”) with the listener call, converts these files to a format compatible with the PSTN 120, and stores these files for future or near-simultaneous playback.

The audio downloader server software 30 also periodically updates the downloaded content with the latest version or episode of the programming. Upon downloading new content, the audio downloader server software 30 might send a notification (e.g., via electronic mail or SMS message) that new programming is available.

The playback server 80 receives calls from the PSTN 120 along with dialed number information and, based upon the dialed number, looks up the associated audio program using the database server software 20, then retrieves the associated audio programming from the audio downloader server software 30 and plays the audio program through the telephone connection.

The playback server 80 might use other information provided during call setup (e.g. calling party identification or carrier identification) in order to determine how to route the call or which audio program to play. The playback server 80 might use information entered on the telephone keypad in order to determine which audio program to play. The playback server 80 might allow for control of the audio program (e.g., pause, rewind, fast-forward) via the telephone keypad. The playback server 80 might allow for a listener to record a message in response to a particular audio program which is delivered back to the publisher or producer of the audio program. The playback server 80 might allow for other informational messages or advertising or sponsorship messages to be played before, during, or after the playing of the audio program.

The servers described above might be combined into a single computer or distributed across many computers, either within a single site or across the Internet. In one aspect, the proposed scope of protection encompasses a method for allowing telephone callers to hear multimedia files syndicated on or otherwise distributed via the Internet. Users request that certain audio programming be made available by phone by entering information about the programming on a web site. The web site provides the user with the corresponding phone number, allocated from a block of available phone numbers.

In a second aspect, the proposed scope of protection encompasses a system that manages the automatic downloading of the latest audio programming per the user requests. Incoming phone calls are received on trunks. A database translates between the dialed phone numbers and the desired audio programming. The desired audio programming is played to the caller.

FIGS. 15-18 will now be used to describe illustrative phonecasting referral systems and methods. The audio content may be, for example, subscription audio content including at least one audio podcast and at least one audio advertisement. FIG. 15 is a diagram of a system 1500 including a server system 1502 and a telephone caller 1516 in audio communication via a connection established through a communication network 1514. In general, the communication network 1514 includes the Internet (e.g., the Internet/World Wide Web 90 of FIG. 14), and may also include the public switched telephone network (e.g., the PSTN 120 of FIG. 14). The server system 1502 is a phonecasting system such as those described previously, and may include, for example, the web front end server software 10, the database server software 20, the audio downloader server software 30, the playback server software 40, the web front end server 50, the database server 60, the audio downloader server 70, and the playback server 80 of FIG. 14.

In the embodiment of FIG. 15, the server system 1502 includes at least one computer system 1504 having a memory system 1506. Software 1508 is stored in the memory system 1506 for execution by the computer's processor(s) (see, e.g., FIG. 2 and related discussion). The software 1508 controls the functions of the server system 1502, and includes referral software 1510. The software 1508 includes telephony engine software such as, for example, the Asterisk® telephony engine software (Digium®, Inc., Huntsville, Ala.). When executed by the computer system 1504, the referral software 1510 causes the server system 1502 to carry out a method for delivering audio content to a referred person.

In the embodiment of FIG. 15, the caller 1516 has placed a telephone call to the server system 1502 via a telephone number corresponding to the audio content as described above, and the server system 1502 is providing the audio content to the caller via an audio signal stream. An audio file 1512 stored in the memory system 1506 of the computer system 1504 of the server system 1502 contains the audio content. In some embodiments, the audio content is subscription audio content including one or more audio podcasts and one or more audio advertisements. The audio podcast(s) included in the audio content may be a recorded verbal communication, such as a speech, a conversation, or an interview. The audio advertisement(s) included in the audio content might be a recorded verbal communication promoting a specific product. Within the audio content, the one or more audio podcasts and the one or more audio advertisements are arranged in sequence. For example, the audio content may include multiple audio podcasts and multiple audio advertisements, wherein each of the audio advertisements is either before, during, or after one of the audio podcasts.

In the embodiment of FIG. 15, the server system 1502 includes hardware and/or software for playing the audio file 1512. The server system 1502 provides the audio signal stream to the caller 1516 via the communication network 1514 as indicated in FIG. 15, enabling the caller 1516 to hear the audio content.

After providing the audio content to the caller 1516, the illustrative referral software 1510 causes the server system 1502 to provide the caller 1516 with an opportunity to share the audio content with another person (i.e., a “referred person” or “friend”). Executing the referral software 1510, the server system 1502 prompts the caller 1516 for information needed to place a telephone call to the referred person (i.e., “referral information”), and receives the referral information from the caller 1516.

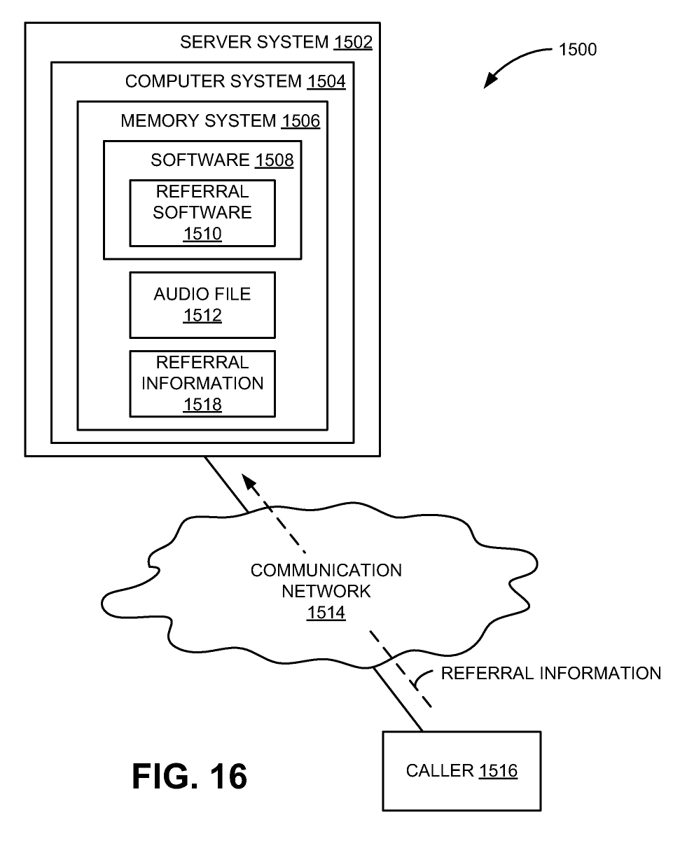

FIG. 16 is a diagram of the system 1500 of FIG. 15 wherein the server system 1502 is receiving the referral information, labeled 1518, from the caller 1516. The referral information can include the caller's phone number and name (possibly obtained using Caller ID or a similar service); a phone number, email address, or other contact information for the referred person; a message to the referred person (i.e., a “referral message”); a phonecast identifier; and a referral time and date. Although some of the referral information can be automatically determined by the server system 1502, the caller is prompted (at a minimum) to provide a contact identifier for the referred person. The caller 1516 may provide referral information by pressing keys on a telephone keypad, or verbally by speaking into a microphone of a telephone handset. Most telephone systems in the United States support tone dialing wherein pressing a key on a telephone keypad causes a specific dual tone multi-frequency (DTMF) audio frequency signal to be generated. Alternatively, the server system 1502 may include voice recognition software, enabling the caller 1516 to provide referral information verbally.

The server system 1502 stores the referral information 1518 provided by the caller 1516, and, in some embodiments, uses the referral information 1518 to place a telephone call to the referred person. In other illustrative embodiments, an email or SMS text message is sent to the referred person.

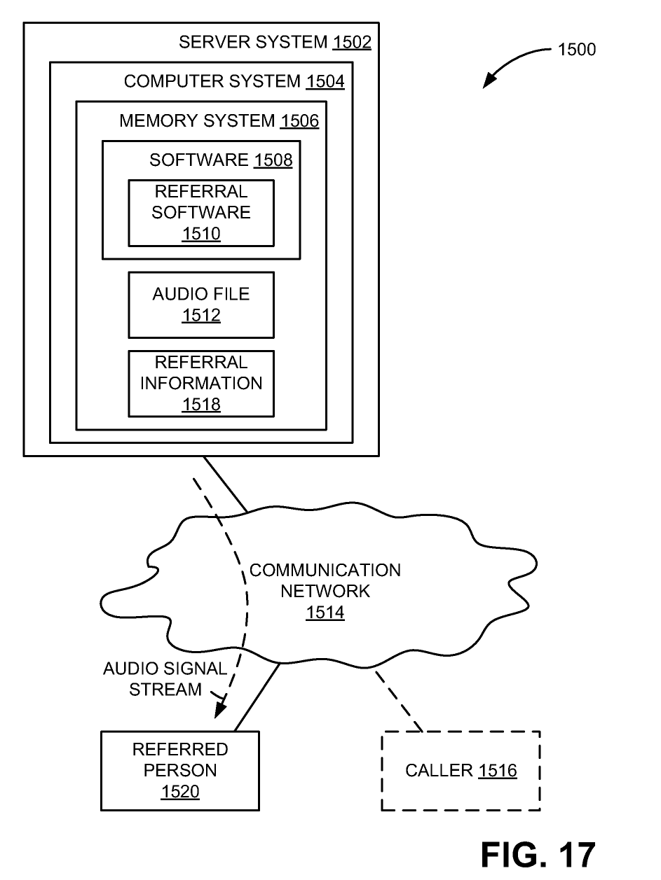

FIG. 17 is a is a diagram of the system 1500 of FIGS. 15-16 wherein the server system 1502 has placed a telephone call to the referred person, labeled 1514, and the server system 1502 is in audio communication with the referred person 1520 via a connection established through the communication network 1514. In general, during the telephone call to the referred person 1520, the server system 1502 delivers a recommendation message (preferably including a referral message from the original caller) to the referred person 1520, then provides the audio content to the referred person 1520 via an audio signal stream. The server system 1502 plays the audio file 1512 again, thereby producing a second audio signal stream conveying the audio content. The server system 1502 provides the second audio signal stream to the referred person 1520 via the communication network 1514 as indicated in FIG. 17, enabling the referred person 1520 to hear the audio content.

In some embodiments, the server system 1502 analyzes the telephone number of the referred person 1520 to determine if the telephone number of the referred person 1520 is a cellular phone (i.e., “cell phone”) number, and offers certain text messaging options only if it is a cell phone number. (If other messaging options are available, the caller is preferably given a choice of all available messaging options, including proprietary messaging services such as Blackberry Messenger.) If the server system 1502 determines that the telephone number of the referred person 1520 is a cell phone number, the caller 1516 is given the option of sending the referred person 1520 a text message (e.g., selectable by pressing the “1” button on a telephone keypad). The server system 1502 then generates a text message that says something like:

“<calleridname> says listen to <audio content>. Call <audio content telephone number>” where <calleridname> is the calling telephone number and/or the name associated with the calling telephone number provided by the Caller ID service when the caller 1516 called the server system 1502, <audio content> is the title of the audio content the caller 1516 listened to and is referring, and <audio content telephone number> is the telephone number corresponding to the audio content (i.e., the telephone number to call to hear the audio content).

Executing the referral software 1510, the server system 1502 sends the text message to the referred person 1520. The short message service (SMS), often called text messaging, is a means of sending short messages to and from cellular phones (i.e., mobile phones). The server system 1502 may, for example, send the text message to the referred person 1520 via the SMS. In many cases, the referred person 1520 is advantageously able to place a call to the telephone number corresponding to the audio content by simply activating the “send” feature on their cell phone.

Whether or not the server system 1502 determines that the telephone number of the referred person 1520 is a cell phone number, the caller 1516 is also given a voice messaging option (e.g., selectable by pressing the “2” button on a telephone keypad). Executing the referral software 1510, the server system 1502 prompts the caller 1516 to “Please record a 20 second message to your friend.” After the caller 1516 records a voice message to the referred person 1520 recommending the audio content, the server system 1502 places a telephone call to the referred person 1520 (i.e., to the telephone number entered by the caller 1516). In some embodiments, a filename of the recorded voice message to the referred person 1520 is passed as a parameter during the process. Once the telephone connection is established via the communication network 1514, the server system 1502 uses the filename of the recorded voice message to accesses the recorded voice message, and plays the recorded voice message to the referred person (or that person's voice mail service) via the telephone connection as an introduction to the audio content. The server system 1502 then prompts the friend for a key press (e.g., “Press any key if you would like to listen to the phonecast now”) and, if the requested input is received, the server system 1502 provides the audio content to the referred person 1520 via the telephone connection (e.g., by playing the audio file 1512).

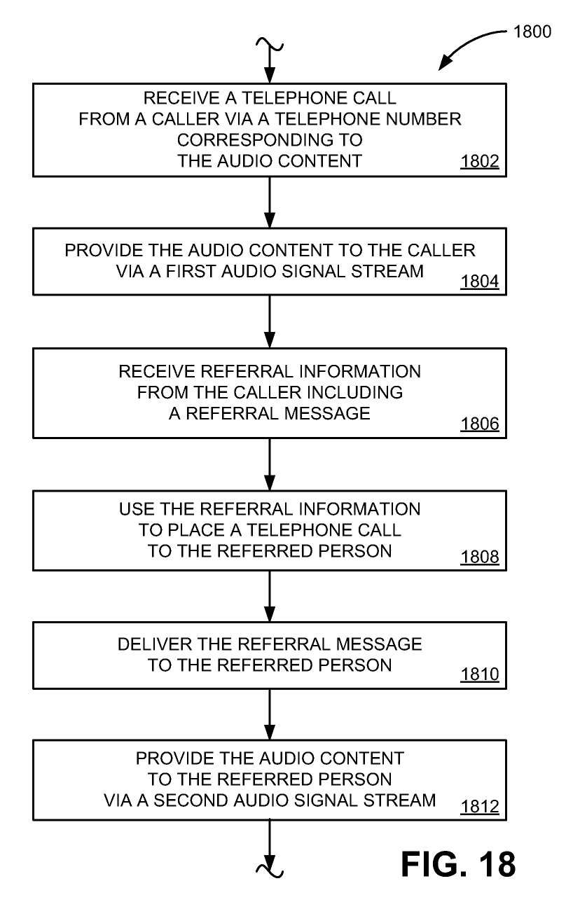

FIG. 18 is a flowchart of one embodiment of a method 1800 for delivering audio content to a referred person. The audio content may be, for example, subscription audio content including one or more audio podcasts and one or more audio advertisements. The referral software 1510 of FIGS. 15-17 may include program instructions for carrying out the method 1800.

During a step 1802 of the method 1800, a telephone call is received from a caller via a telephone number corresponding to the audio content. That is, a telephone call is received from the caller who has dialed the telephone number corresponding to the audio content. The audio content is provided to the caller via a first audio signal stream during a step 1804. During a step 1806, referral information is received from the caller, including at least contact information for the referred person. The referral information, which may include a referral message from the caller, will be used to generate a recommendation message to the referred person. As described above, the recommendation message may be a text message, email, or a voice message including a referral message from the caller.

During a step 1808, the referral information is used to send a message to the referred person, e.g., in the form of a phone call, a voice message, a text message, an email, or a communication via some other mechanism. A recommendation (including the referral message, if any) is delivered to the referred person during a step 1810, preferably with an easy way for the referred person to access the audio content. If the referred person keeps listening to the phone call or otherwise accesses the phonecast, the audio content is provided to the referred person via a second audio signal stream during a step 1812.

It is noted that in the system 1500 of FIG. 15-17, the server system 1502 may provide the caller 1516 with the opportunity to share the audio content with another person at any time during the call placed by the caller 1516. For example, if the caller 1516 presses any key (or a specific key) on a telephone keypad while the server system 1502 is providing the audio content, the server system may interrupt the providing of the audio content and provide the caller 1516 with one or more options, including the option to share the audio content with another person. The caller 1516 may respond to the one or more options provided by the server system 1502 by pressing keys on the telephone keypad. Alternately, or in addition, the server system 1502 may include voice recognition software as described above, allowing the caller 1516 to respond verbally.

A number of novel phonecasting referral system and method embodiments have been disclosed. Numerous variations and modifications will become apparent to those skilled in the art once the above disclosure is fully appreciated. For example, episode numbers or identifiers may also be included in recommendation messages. It is intended that the following claims be interpreted to embrace all such variations and modifications.

As one example, the illustrative methods shown in the figures present actions in a sequential series. Those skilled in the programming arts are aware of various parallel and distributed programming methods that can achieve similar results while permitting similar actions to be taken out of sequence, concurrently, or simply as needed. Moreover, the sequences shows are given for illustrative purposes, and in practice many of the actions would be re-ordered, omitted, inserted, or repeated as desired.

As yet another example, the telephony software can be readily extended to buffer, translate, and play live audio streams publicly available on the Internet. For such feeds, some or all of the download server operations may be omitted.

A number of applications of the disclosed referral methods should be readily apparent. Phonecasts can be used as a type of audible directory, with service and product providers providing descriptions of their services or goods and inviting the listener to press a key for further information, to connect to a live consultant, or to initiate a purchase. In such a context, referrals will serve as business recommendations and networking opportunities. Podcast providers may hold contests or provide rewards for referrals, thereby obtaining effective word-of-mouth advertising with a minimal budget. As yet another example, political or charitable organizations may use these systems and methods to organize “grass-roots” campaigns.

What is claimed is:

1. A phonecasting referral method that comprises:
receiving an incoming phone call from a caller;
playing an audio feed; and
receiving contact information for a referred person from the caller.

2. The method of claim 1, further comprising:
receiving a referral message via the incoming phone call.

3. The method of claim 1, wherein the contact information is a phone number.

4. The method of claim 1, wherein the contact information is an email address.

5. The method of claim 1, further comprising:
capturing caller identifying information associated with the incoming phone call.

6. The method of claim 5, further comprising:
communicating a recommendation message to the referred person.

7. The method of claim 6, wherein said communicating includes initiating a phone call to the referred person.

8. The method of claim 7, wherein the recommendation message includes a voice message from the caller.

9. The method of claim 6, wherein said communicating includes sending an automatically generated text message or email to the referred person.

10. The method of claim 9, wherein the recommendation message includes identifying information for said caller and a phone number associated with the audio feed.

11. A phonecasting system that comprises:
one or more memories that store phonecasting software; and
one or more processors coupled to the memory to execute the software,
wherein the software configures the one or more processors to:
receive a phone call from a caller;
play a podcast; and
detect a phone number for a referred person.

12. The system of claim 11, wherein the software stores the phone number for the referred person in a database that associates the phone number with other referral information.

13. The system of claim 12, wherein the referral information includes identifying information for said caller.

14. The system of claim 13, wherein the referral information further includes a referral message from said caller to the referred person.

15. The system of claim 14, wherein the referral information further includes a podcast identifier.

16. The system of claim 14, wherein the phonecasting software configures one or more processors to generate a recommendation message based on the referral information and communicate the recommendation message to the referred person.

17. The system of claim 16, wherein the recommendation message is a text message.

18. The system of claim 16, wherein the recommendation message is a phone call or voice mail.
